(19) United States
(12) Patent Application Publication
(10) Pub. No.: US 2024/0036844 A1
(43) Pub. Date: Feb. 1, 2024

(54) DEPLOYMENT METHOD AND DEPLOYMENT DEVICE OF HETEROGENEOUS PLATFORM BASED ON TVM COMPILER

(71) Applicant: Shenzhen Intellifusion Technologies Co., Ltd., Shenzhen, Guangdong (CN)

(72) Inventor: Jinjin WU, Shenzhen, Guangdong (CN)

(21) Appl. No.: 17/623,902

(22) PCT Filed: Apr. 21, 2021
(86) PCT No.: PCT/CN2021/088594

§ 371 Date: Sep. 25, 2023

(30) Foreign Application Priority Data
Jul. 10, 2020 (CN) 202010654954.X

(51) Int. Cl. G06F 8/60; G06F 8/41

(52) U.S. Cl. CPC G06F 8/60; G06F 8/41

(57) ABSTRACT

Provided are a deployment method and apparatus for a heterogeneous platform based on a TVM compiler, and a terminal device. The method comprises: obtaining a topological structure diagram, network parameters and function information of each function of a deep learning network generated by a TVM compiler (S101); on the basis of information of a node in the topological structure diagram and the device type of a heterogeneous platform, dividing the node in the topological structure diagram into target device blocks corresponding to the device type (S102); performing space allocation on the target device blocks to obtain space information of the target device blocks (S103); and deploying the deep learning network to the heterogeneous platform on the basis of the topological structure diagram, the network parameters, the function information, the target device blocks and the spatial information of the target device blocks (S104). According to the method, the node is divided into target device blocks of different device types, and deployment of different devices in the heterogeneous platform is completed by means of the target device blocks of different types.

### TECHNICAL FIELD

The present disclosure generally relates to the technical field of data processing, and especially relates to a deployment method and a deployment device of a heterogeneous platform based on a TVM compiler.

This application claims the benefit of priority from Chinese Patent Application No. 202010654954.X, entitled “DEPLOYMENT METHOD AND DEPLOYMENT DEVICE OF HETEROGENEOUS PLATFORM BASED ON TVM COMPILER” and filed on Jul. 10, 2020, the content of which is hereby incorporated by reference in its entirety.

### DESCRIPTION OF RELATED ART

A heterogeneous platform is an operation platform with different types of instruction sets and architecture calculation units, and supports architectures of different systems, which can be composed of processors such as CPU, GPU, DSP, ASIC, FPGA etc.

At present, deployment of hardware platforms is performed mostly for a single hardware platform with one instruction set and one type of architecture calculation unit, and a deployment method for the heterogeneous platform is lacked.

### SUMMARY

### Technical Problems

### Solution of the Problems

### Technical Solutions

The present disclosure relates to a deployment method, a deployment device of a heterogeneous platform based on a TVM compiler, and the deployment method and the deployment device can deploy a deep learning network to the heterogeneous platform.

In a first respect, a deployment method of a heterogeneous platform based on a TVM compiler according to an embodiment of the present disclosure includes:
obtaining a topological structure diagram, a network parameter and function information of each function of a deep learning network generated by the TVM compiler;
dividing nodes in the topological structure diagram into target device blocks corresponding to device types, based on information of the nodes in the topological structure diagram and the device types of the heterogeneous platform;
performing space distribution on the target device block, to obtain space information of the target device block; and
deploying the deep learning network to the heterogeneous platform, based on the topological structure diagram, the network parameter, the function information, the target device block and the space information of the target device block.

In a second respect, a deployment device of a heterogeneous platform based on a TVM compiler according to an embodiment of the present disclosure includes:
a data acquisition module configured to obtain a topological structure diagram, a network parameter and function information of each function of a deep learning network generated by the TVM compiler;
a node dividing module configured to divide nodes in the topological structure diagram into target device blocks corresponding to device types, based on information of the nodes in the topological structure diagram and the device types of the heterogeneous platform;
a space distribution module configured to perform space distribution on the target device block, to obtain space information of the target device block; and
a network deployment module configured to deploy the deep learning network to the heterogeneous platform, based on the topological structure diagram, the network parameter, the function information, the target device block and the space information of the target device block.

In a third respect, a terminal device according to an embodiment of the present disclosure includes a memory, a processor and computer programs stored in the memory and performed by the processor, when the computer programs are performed by the processor, the terminal device can be configured to implement steps of the deployment method above mentioned in the first aspect.

In a fourth respect, a computer readable storage medium according to an embodiment of the present disclosure is configured to store computer programs, when the computer programs are performed by a processor to implement steps of the deployment method above mentioned in the first aspect.

In a fifth respect, a computer program product according to an embodiment of the present disclosure is configured to be performed by a terminal device, when the computer programs are performed by a processor, the terminal device can be configured to implement steps of the deployment method above mentioned in the first aspect.

It is understood that beneficial effects of the second aspect to the fifth aspect can be referred to related descriptions of the first aspect, and are not repeated herein again.

Comparing with the related art, the present disclosure provides the advantages as below: dividing the nodes in the topological structure diagram into the target device blocks corresponding to the device types of the heterogeneous platform through obtaining the information of the nodes in the topological structure diagram generated by the TVM compiler, and then, performing space distribution on the target device blocks, to obtain space information of each target device block, and finally deploying the information of each target device block to a device of the heterogeneous platform, based on the obtained network parameter, the function information of each function, the topological structure diagram, the target device blocks and the space information of the target device blocks generated by the TVM compiler, so as to complete deployment of the heterogeneous platform. The present disclosure divides the nodes into the target device blocks with different device types, and completes the deployment of different devices in the heterogeneous platform through different types of target device blocks; in this way, compared with the prior art in which only a single device platform can be deployed, the present disclosure can ensure integrity of the deep learning network, and deploy the deep learning network based on the TVM compiler, to support the deep learning network that has been obtained by different deep learning frameworks.

### Advantages of the Disclosure

### BRIEF DESCRIPTION OF THE DRAWINGS

### Drawings Description

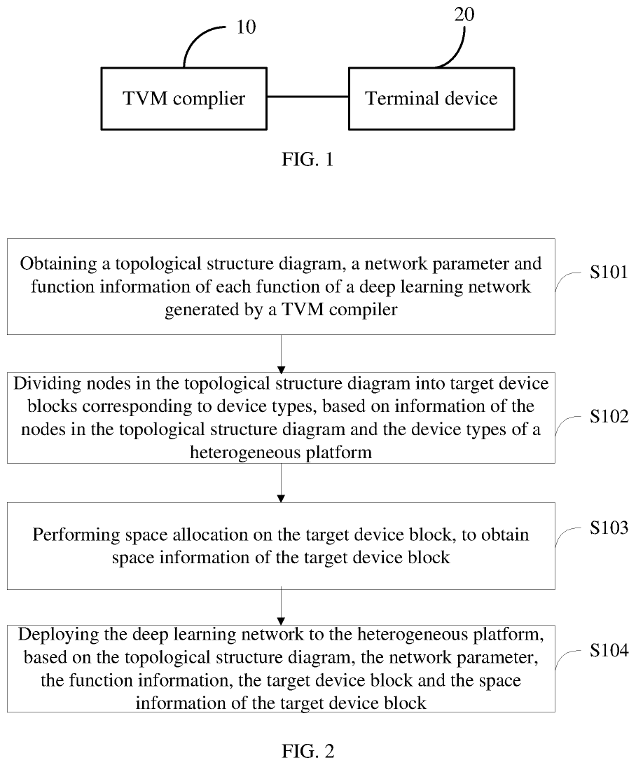

FIG. 1 is an application scenario schematic diagram of a deployment method of a heterogeneous platform based on a TVM compiler according to an embodiment of the present disclosure.

FIG. 2 is a schematic flowchart of the deployment method of the heterogeneous platform based on the TVM compiler according to an embodiment of the present disclosure.

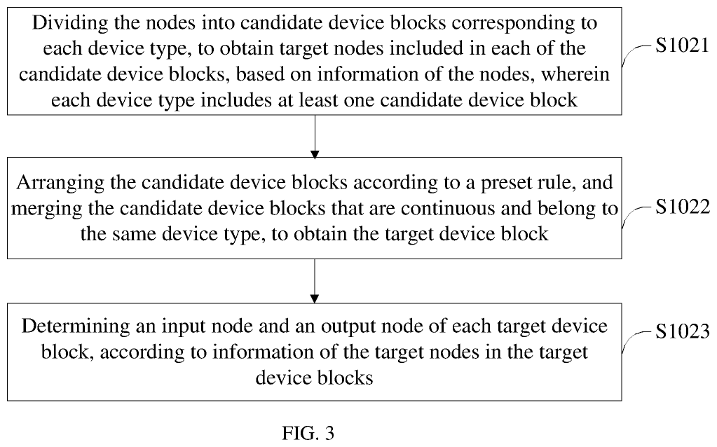

FIG. 3 is a flowchart of dividing target device blocks of FIG. 2 according to an embodiment of the present disclosure.

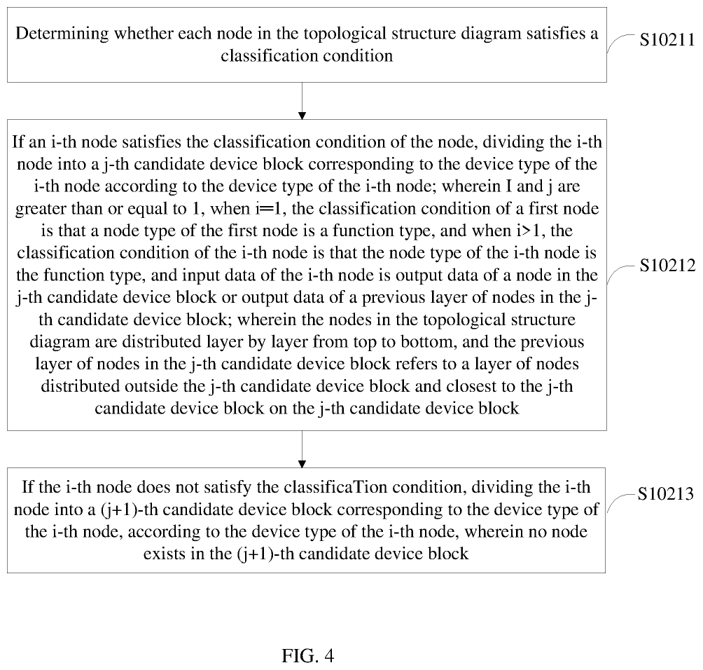

FIG. 4 is a first flowchart of dividing nodes according to an embodiment of the present disclosure.

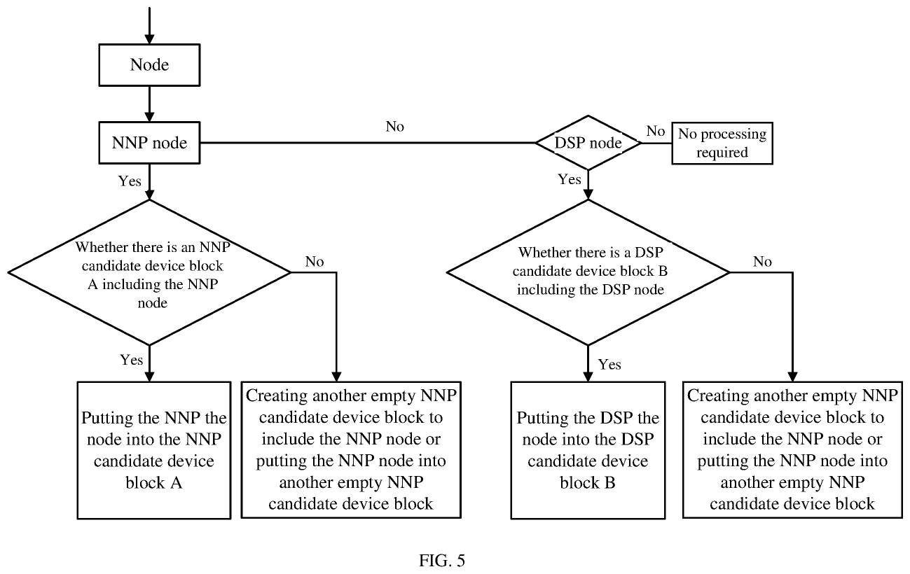

FIG. 5 is a second flowchart of dividing the nodes according to an embodiment of the present disclosure.

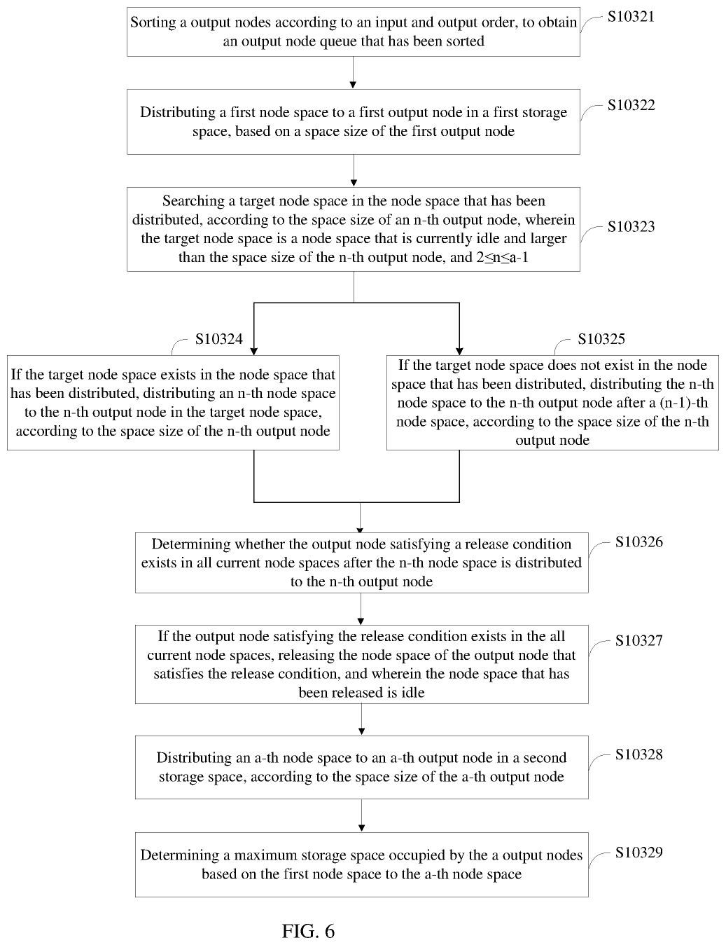

FIG. 6 is a schematic flowchart of a node space distribution method according to an embodiment of the present disclosure.

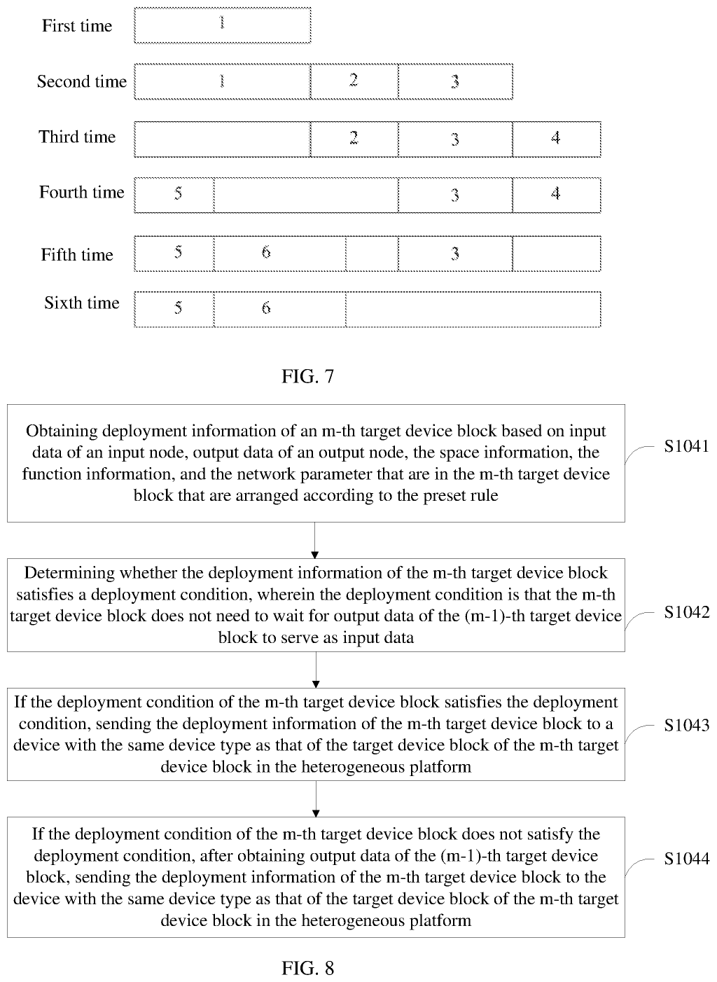

FIG. 7 is a schematic flowchart of a specific space distribution method according to an embodiment of the present disclosure.

FIG. 8 is a schematic flowchart of a platform deployment method according to an embodiment of the present disclosure.

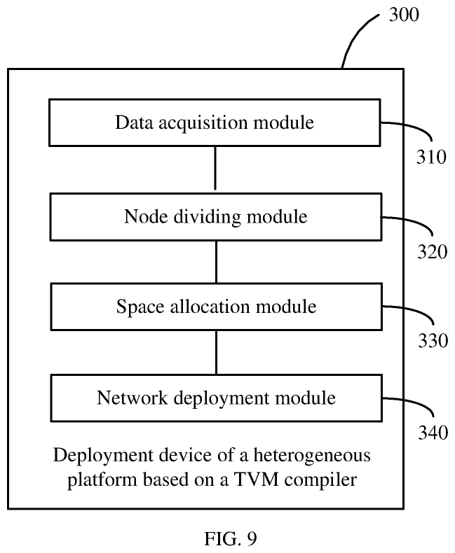

FIG. 9 is a schematic diagram of a deployment device of a heterogeneous platform based on a TVM compiler according to an embodiment of the present disclosure.

### DETAILED DESCRIPTION

### Embodiments of the Disclosure

FIG. 1 is an application scenario schematic diagram of a deployment method of a heterogeneous platform based on a TVM (Tensor Virtual Machine) compiler according to an embodiment of the present disclosure. The deployment method of the heterogeneous platform based on the TVM compiler can be configured to deploy a deep learning network for the heterogeneous platform. A TVM compiler 10 is configured to generate data of the deep learning network to be deployed, a terminal device 20 is configured to obtain the data generated by the TVM compiler 10, perform device block classification on the data that has been obtained, and finally deploy the deep learning network to the heterogeneous platform, based on the data that has been obtained, and the device blocks that has been divided, so as to implement deployment of the heterogeneous platform.

In a specific application, the heterogeneous platform can include a plurality of processors. The present disclosure is mainly described for the heterogeneous platform composed of an NPU (Neural-Network Processing Units) and a DSP (Digital Signal Processing). The NPU is specifically adopted an NNP (Neural Network Processor), the following specific embodiments are described with reference to the above heterogeneous platform as an example, and it should be noted that the above heterogeneous platform is only an example, and should not be limited to the deployment method of the present disclosure.

The deployment method of the heterogeneous platform based on the TVM compiler according to an embodiment of the present disclosure is described in detail below in combination with FIG. 1.

FIG. 2 is a schematic flowchart of the deployment method of the heterogeneous platform based on the TVM compiler of the present disclosure. Referring to FIG. 2, the deployment method is described in detail as follows:
step S101, obtaining a topological structure diagram, a network parameter and function information of each function of the deep learning network generated by the TVM compiler.

In an embodiment of the present disclosure, the TVM compiler can be configured to compile the deep learning network generated by different deep learning network frameworks, and the deep learning network that has been compiled by the TVM compiler can generate the topological structure diagram, the network parameter, and the function information of each function.

The topological structure diagram includes information of nodes, the nodes in the topological structure diagram are arranged layer by layer, a node corresponding to a unique index code, wherein the node refers to a module that stores or processes data in an operation process of the deep learning network.

The information of the node can include a device type of the node, a node type of the node, information of output data of the node, information of input data of the node, structural information of the node, and a data type of the node etc. The node type of the node can include a function type and the data type, the node of the function type (TVM OP (Tensor Virtual Machine Operator-TVM operation)) refers to the node of the function type that has been compiled by the TVM complier, which can be a function, and can process the data; the node of the data type refers to that the node only stores data rather than processing the data. The information of the output data of the node includes one or more output tensors, one output tensor is a multidimensional array; the information of the input data of the node includes one or more input tensors, one input sensor is a multidimensional array; the structure information of the node can include scale information of the node, channel information, width information and height information, etc. The data type of the node can include an integer (int), a short integer (short), and a single precision floating point (float32 or float16), etc.

The device types of the nodes correspond to the device types of the heterogeneous platform, which device types are included in the heterogeneous platform, which device types are included in the nodes. The device type of the node has been set according to the device type of the heterogeneous platform when the topological structure is generated by the TVM compiler. A type of the device type of the node corresponds to that of the device type of the heterogeneous platform to be deployed, for example, the heterogeneous platform can be an NNP platform and a DSP platform, so that the device type of the heterogeneous platform includes the NNP and the DSP, and the device type of the node also includes a node of the NNP type and a node of the DSP type.

The network parameter refers to weight (weight) data of the deep learning network, the function information of the function is in the form of a lib file, and refers to an assembly code of the function or information required by the performance function.

Step S102, dividing the nodes in the topological structure diagram into target device blocks corresponding to the device types, based on the information of the nodes in the topological structure diagram and the device types of the heterogeneous platform.

In an embodiment of the present disclosure, the target device block is divided mainly according to the node type, the device type, the input data of the node, and the output data of the node in the node information, wherein the nodes of the function type in the topological structure diagram are divided into different target device blocks.

Referring to FIG. 3, in a possible implementation, an implementation process of the step S102 can include:
step S1021, dividing the nodes into candidate device blocks corresponding to each device type, to obtain target nodes included in each of the candidate device blocks, based on the information of the nodes, wherein each device type includes at least one candidate device block.

In an embodiment of the present disclosure, one device type can include one or at least two candidate device blocks, and specifically, how many candidate device blocks are determined based on a classification condition of the nodes.

As an example, the NNP device type can include an NNP candidate device block or two or more NNP candidate device blocks.

Referring to FIG. 4, in a possible implementation, an implementation process of the step S1021 can include:
step S10211, determining whether each node in the topological structure diagram satisfies a classification condition.

In an embodiment of the present disclosure, one node corresponds to one unique index code, and the node can be indexed according to the index code of the node.

step S10212, if an i-th node satisfies the classification condition of the node, dividing the i-th node into a j-th candidate device block corresponding to the device type of the i-th node, according to the device type of the i-th node; wherein i and j are greater than or equal to 1, when i=1, the classification condition of a first node is that the node type of the first node is the function type, and when i>1, the classification condition of the i-th node is that the node type of the i-th node is the function type, and input data of the i-th node is output data of a node in the j-th candidate device block or output data of a previous layer of nodes in the j-th candidate device block; wherein the nodes in the topological structure diagram are distributed layer by layer from top to bottom, and the previous layer of nodes in the j-th candidate device block refers to a layer of nodes distributed outside the j-th candidate device block and closest to the j-th candidate device block on the j-th candidate device block.

In an embodiment of the present disclosure, if the node is the first node and the device type of the first node is the DSP, the first node can be placed into the DSP candidate device block only if the node type of the first node is the function type. Because the node is the first node, all DSP candidate device blocks are empty, so that the first node can be placed into any one of the DSP candidate device blocks. If the node is a third node, it is first to determine whether the node is a node of the function type, if the node is not a node of the function type, directly discarding the node without subsequent determination; if the third node is a node of the function type and the DSP type, it is to determine input data of the third node, if the input data of the third node is output data of one node of a first DSP candidate device block, bringing the third node into the first DSP candidate device block; if the third node is a node of the function type and the DSP type, the input data of the third node is output data of one node in a layer of nodes that is outside the first DSP candidate device block and is closest to the first DSP candidate device block on the first DSP candidate device block, in this way, the third node is included in the first DSP candidate device block.

In an embodiment of the present disclosure, the candidate device block can be a preset empty device block, or a device block that is created according to determination of the node.

As an example, the device type of the first node is the NNP, if there is a pre-created NNP candidate device block, the first node is included in the NNP candidate device block, and if there is no pre-created NNP candidate device block, the NNP candidate device block can be newly created, so that the first node is included in the NNP candidate device block that has been newly created.

Step S10213, if the i-th node does not satisfy the classification condition, dividing the i-th node into a (j+1)-th candidate device block corresponding to the device type of the i-th node, according to the device type of the i-th node, wherein no node exists in the (j+1)-th candidate device block.

In an embodiment of the present disclosure, if the i-th node does not satisfy the classification condition, that is, the i-th node can't be placed in any candidate device block with the nodes therein, the i-th node needs to be received in an empty candidate device block, the (j+1)-th candidate device block can be a pre-existing empty candidate device block or a newly-created empty candidate device block when the i-th node does not satisfy the classification condition, for example, there can have been three NNP candidate device blocks in which the nodes of the NNP device type are received, a sixth node is a node of the function type and the NNP type, input data of the sixth node is not output data of the nodes in the three NNP candidate device blocks described above, and the input data of the sixth node is also not output data of a previous layer of nodes of any of the three NNP candidate device blocks, then the sixth node is placed in a fourth NNP candidate device block.

As an example, referring to FIG. 5, if the nodes of two device types, namely, the node of the NNP type and the node of the DSP type, are included, when a node comes in, first determining whether the node is the node of the NNP function type;
if the node belongs to the node of the NNP function type, searching whether an NNP candidate device block A exists for including the node therein, and if the input data of the node comes from the nodes in the DSP candidate device block A or from a previous layer of nodes in the NNP candidate device block A, the node can be placed in the NNP candidate device block A; otherwise, the node is brought into the empty NNP candidate device block without any node therein, or the node is brought into the NNP candidate device block that has been newly created;
if the node is not the node of the NNP function type, determining whether the node is the node of the DSP function type;
if the node belongs to the DSP function type, searching whether a DSP candidate device block B exists for including the node therein, and if the input data of the node comes from nodes in the DSP candidate device block B or from a previous layer of nodes in the DSP candidate device block B, the node can be placed in the DSP candidate device block B; otherwise, the node is brought into an empty DSP candidate device block without any node therein, or the node is brought into the DSP candidate device block that has been newly created;
if the node is neither the node of the NNP function type, nor the node of the DSP function type, no processing is required.

It should be noted that, if a current node includes at least two input data that come from at least two candidate device blocks, it is also necessary to divide the current node into the (j+1)-th candidate device block corresponding to the device type of the current node, according to the device type of the current node.

As an example, if the node is the node of the function type and the DSP type, and one input data of the node is from a node in a third DSP candidate device block and the other input data is from a node in a second NNP candidate device block, the node needs to be placed in an empty DSP candidate device block, and if there is no empty DSP candidate device block, a DSP candidate device block can be newly created.

In an embodiment of the present disclosure, because the node of the function type is the node that needs to be calculated or otherwise processed, and the node of the data type is only configured to store data, rather than processing the data, and exists depending on the node of the function type, in this way, the node of the function type only needs to be classified, and then the candidate device block corresponding to each node of the data type can be obtained. Classification rules are set during performing node classification, not only the nodes with input and output relations can be divided into a block, but also the nodes without any association can be divided into the candidate device block, so that the nodes without the association can be calculated in parallel in the candidate device block. By adopting the deployment method of the present disclosure, the nodes of all function types can be accurately and quickly classified, and the nodes of different device types can be classified, to facilitate subsequent deployment of different devices in the heterogeneous platform, the deployment of the heterogeneous platform can be performed by adopting the device block, the data required by the devices of different device types can be separated, so that deployment errors caused by too many nodes or the nodes of different device types can be avoided during the deployment.

Step S1022, arranging the candidate device blocks according to a preset rule, and merging the candidate device blocks that are continuous and belong to the same device type, to obtain the target device block.

In an embodiment of the present disclosure, each node has an index code, when the candidate device blocks are arranged, all the candidate device blocks can be sequentially arranged from small to large, according to a size of the index code of a first target node in the candidate device blocks. After the arrangement, if the candidate device blocks of the same device type are continuous, the continuous candidate device blocks of the same device type are merged, to obtain the target device block that has been merged. Of course, each candidate device block that does not need to be merged is the target device block, the target device block corresponding to the unique index code.

Specifically, a method for determining whether the candidate device blocks of the same device type are continuous can be to obtain adjacent candidate device blocks of the same device type by first searching the candidate device blocks, and then, it is determined whether the adjacent candidate device blocks of the same device type are continuous based on the index codes of the candidate device blocks; if the index codes are continuous, it indicates that the adjacent candidate device blocks of the same device type are continuous, and if the index codes aren't continuous, it indicates that the adjacent candidate device blocks of the same device type are not continuous.

For example, a candidate device block a is of the NNP type, and the index code of a first target node in the candidate device block a is 3; a candidate device block b is of the NNP type, and the index code of a first target node in the candidate device block b is 2; a candidate device block c is of the NNP type, and the index code of a first target node in the candidate device block c is 5; a candidate device block d is of the DSP type, and the index code of a first target node in the candidate device block d is 4; a candidate device block e is of the DSP type, and the index code of a first target node in the candidate device block e is 1;

An order according to an ascending order of the index codes is e, b, a, d and c, because both the candidate device block b and the candidate device block a are continuous and of the NNP types, so that the candidate device blocks b and a can be merged into the candidate device block f, to obtain the candidate device blocks e, f, d and d arranged in order; each of the candidate device blocks e, f, d and c is the target device block, and each target device block corresponds to the index code.

Step S1023, determining an input node and an output node of each target device block, according to information of the target node in the target device block.

In an embodiment of the present disclosure, when hardware deployment is performed on the target device block, it is necessary to know input and output of the target device block, and the target device block includes a plurality of target nodes therein. When determining the input node and the output node of the target device block, indexing the target device block one by one according to the index code of the target device block, searching the input node and the output node of each target node in the target device block, and finally indexing all target nodes in each target device block, so as to determine the input node and the output node of each target device block.

The input node only includes the node corresponding to input data outside the target device block, and excludes the input node for input and output transmission between internal nodes. The output node is only a node corresponding to output data of the target device block which needs to be output finally, and excludes the node for input and output transmission between the internal nodes.

In a possible implementation, an implementation process of the step S1023 can include:
step S10231, if the input node of the target node in the target device block satisfies an input node inclusion condition, the input node of the target node is included in a current target device block and taken as the input node of the target device block, wherein the input node inclusion condition includes that, when the input node of the target node is the node of the data type, corresponding data is the input data of the deep learning network, or the input node of the target node is the node of the function type without being included in the current target device block.

In an embodiment of the present disclosure, since it is only necessary to determine an external input node in the target device block, it only needs to search that the input data of the target node is output data from the external node of the target device block. If the input data of the target node is the node of the data type, and the input data of the deep learning network, the node is the input node of the target device block, and included in an input node set in the target device block, wherein the input data of the deep learning network is data input by the user and is known data. If the input data of the target node is the node of the function type, and is not in the target device block where the target node is located, that is, the node is a node in other target device blocks, the node should also be included in the input node set of the target device block where the target node is located.
step S10232, the target node in the target device block that satisfies an output node inclusion condition is the output node of the current target device block, wherein the output node inclusion condition includes that the target node is in an output list of the deep learning network, or the output data of the target node is the input data of the target node in the target device block except the current target device block.

In an embodiment of the present disclosure, since all the target nodes are the nodes of the function types, and are the nodes that need to output data after data processing, so that one target node is the output node and corresponds to one output data. When determining the output node of the target device block, it is only necessary to determine whether the target node in the target device block satisfies the output node inclusion condition. If the target node is in the output list of the deep learning network, that is, the current target node is included in the output list, the current target node is the output node of the target device block, and if the current target node is not in the output list, but the output data of the current target node is the input data of other target device blocks, the current target node is also taken as the output node of the target device block.

It should be noted that the target node, the input node, and the output node stored in the target device block are all stored with the index code of the node, that is, only the index code of the node needs to be recorded when the target node, the input node, and the output node are determined, the index code of the node in the topological structure diagram is stored in the target device block, and parameters and the data information of relevant nodes can be obtained when the target device block is scheduled through the index code.

In an embodiment of the present disclosure, when the input node and the output node of the target device block are determined, a node inclusion condition is set, whether the node is the input node or the output node can be quickly determined, according to the node inclusion condition, and the determination of the input node and the output node lays a foundation for subsequent space distribution and hardware deployment.

In an embodiment of the present disclosure, the candidate device blocks are arranged and merged in sequence, and then the input node and the output node of the target device block are determined; if the input node and the output node of the candidate device block are first determined, the input node and the output node between the candidate device blocks need to be removed after the candidate device blocks are merged, so that a screening process of the output node and the output node is increased and complicated. While, the output node and the output node are determined after the candidate device blocks are merged, so there is no problems that the nodes of internal transmission are included in the input node and output node, which is simpler.

For example, the target device blocks include an NNP target device block that includes the target nodes A and B, and a DSP target device block that includes the target nodes C and D, in this way, it is to determine the input nodes and the output nodes of all target device blocks.

Determining whether the current target device block is the NNP target device block or the DSP target device block, if the current target device block is the NNP target device block, searching the input nodes of the target node A include the nodes E, F, both the node E and the node F are the nodes of the data types, and output data of the nodes E, F are the input data of the deep learning network, in this way, both the node E and the node F are the input nodes of the NNP target device block; if searching the input node of the target node B only includes the target node A, the target node A does not satisfy the input node inclusion condition and does not belong to the input node of the NNP target device block; the target node A is not in the output list of the deep learning network, and there is no node in the DSP target device block that takes the output data of the target node A as the input data, so the target node A is not the output node of the target device block. The target node B is not in the output list of the deep learning network, but the output data of the target node B is the input data of the target node C in the DSP target device block, so the target node B is the output node of the NNP target device block.

If the current target device block is the DSP target device block, searching the input nodes of the target node C includes a node B and a node G, then the input nodes of the target node C are the node B and the node G that are taken as the input node set to be included in the input node list of the current target device block; and the node C is taken as the output node set and included in the output node list of the current target device block. Searching the input node of the target node D only includes the target node C, in this way, the node C is taken as the input node set of the target node D and included in the input node list of the current target device block; and the node D is taken as the output node set and included in the output node list of the current target device block.

Furthermore, the input node list of the NNP target device block is [E, F], and the output node list of the NNP target device block is [B]; the input node list of the DSP target device block is [[B, G], [C]], and the output node list of the DSP target device block is [[C], [D]].

It should be noted that, the NNP target device block and the DSP target device block have different structures, the NNP target device block has only one layer for performing calculation, so the output is a group of output data, each single node in the DSP target device block can be calculated as one layer, the output is a plurality of groups of output data, so that the output node and the input node of each layer need to be determined.

Step S103, performing space distribution on the target device block, to obtain space information of the target device block.

In an embodiment of the present disclosure, if the output data of the input node of the target device block is the input data of the deep learning network, the data is input by a user, and space distribution is not performed, and if the input data of the input node is the output data of the target node of other target device blocks, the input node is the output node of other target device blocks. Therefore, in the space distribution, only the output nodes in the target device block need to be performed the space distribution, and the space distribution includes storage address distribution. In the present disclosure, the storage address distribution is distributed based on a base address to only distribute an offset address.

In a possible implementation, an implementation process of the step S103 may include:

step S1031, calculating a space size of each output node, based on scale information and the data type of each output node in the target device block.

In an embodiment of the present disclosure, the space size is calculated as the product of the scale information and the data type. With the space size, it can be known how much space should be occupied by the output node, that is, how many addresses should be occupied.

Step S1032, obtaining a maximum storage space required to be occupied by all the output nodes, based on the space size of each output node, and taking the maximum storage space as the space information of the target device block.

In an embodiment of the present disclosure, if the target device block includes only one output node, only the node space is distributed to the output data of the only one output node, if the target device block includes a plurality of output nodes, the node space needs to be distributed to each output node, and after the node space is distributed to all the output nodes in the target device block, the maximum storage space that is occupied by all the output nodes can be obtained.

In an embodiment of the present disclosure, the space distribution is performed on the output node through the space size of the output node, the address space occupied by the output node can be accurately obtained, meanwhile, the space distribution is only performed on the output node in the target device block, so that the node space that is occupied can be reduced, and the distribution process can be accelerated.

Referring to FIG. 6, in a possible implementation, an implementation process of step S1032 can include:
step S10321, sorting a output nodes according to an input and output order, to obtain an output node queue that has been sorted.

In an embodiment of the present disclosure, when performing space distribution on the output node, the target device blocks are indexed one by one through the index codes of the target device blocks, and the nodes are indexed by the index codes of the nodes, so that the node with a previous index code is indexed according to the input and output order, that is, all the output nodes are sorted according to the input and output order.

For example, the output node in the target device block A is a, the output node in the target device block B is b, and the target device block A is precedes the target device block B, so the output node a is first indexed, and then the output node b is indexed, and the output nodes a, b are ordered as the output node a is first and the output node b is after the output node a.

Step S10322, distributing a first node space to a first output node in a first storage space, based on the space size of the first output node.

In an embodiment of the present disclosure, as the node is the first output node, the space that can be distributed in the first storage space is not occupied, so the first output node can be directly performed space distribution to obtain the node space. The first node space includes a first address and a last address for storing the first output node.

In an embodiment of the present disclosure, the space can include a data space and a global space, the data space is a reusable space, that is, the same node space can be used by different output nodes at different times, in the present disclosure, the first storage space refers to the data space; the global space is a space that can't be reused, after one output node occupies the node space, the node space can't be used by other output nodes, in the present disclosure, the second storage space refers to the global space.

Step S10323, searching a target node space in the node space that has been distributed, according to the space size of an n-th output node, wherein the target node space is a node space that is currently idle and larger than the space size of the n-th output node, and 2≤n≤a−1.

In an embodiment of the present disclosure, when the node space is distributed to the n-th output node, since the output node that has been distributed occupies a part of the node space, the node space that can be used by the n-th output node needs to be searched in the node space that has been released, that is, the node space is idle; the node space that can be used by the n-th output node should be larger than the space size of the n-th output node.

Step S10324, if the target node space exists in the node space that has been distributed, distributing an n-th node space to the n-th output node in the target node space, according to the space size of the n-th output node.

In an embodiment of the present disclosure, if there is a node space is idle and larger than the space size of the n-th output node, the n-th node space can be distributed to the n-th output node in the node space, so as to implement to reuse the node space.

Step S10325, if the target node space does not exist in the node space that has been distributed, distributing the n-th node space to the n-th output node after a (n−1)-th node space, according to the space size of the n-th output node.

In an embodiment of the present disclosure, if there is no target node space, a corresponding node space can be distributed to the n-th output node in the first storage space, and if there is no space in the first storage space that satisfies the space size of the n-th output node.

Step S10326, determining whether the output node satisfying a release condition exists in all current node spaces, after the n-th node space is distributed to the n-th output node. In an embodiment of the present disclosure, the node satisfying the release condition includes: the input node that does not belong to the output node after the n-th output node, and is not the input node of the n-th output node.

Step S10327, if the output node satisfying the release condition exists in all the current node spaces, releasing the node space of the output node that satisfies the release condition, and the node space that has been released is idle.

In an embodiment of the present disclosure, after the n-th output node is distributed, arranging the node spaces that have been distributed in the ascending order, and then checking whether there is any node space that needs to be released in the current existing node space, if so, releasing the node space, so that only the node space of the output node needed by the n-th output node for calculation is stored in the current node space.

In an embodiment of the present disclosure, the node space of the output node needed by the n-th output node for calculation, includes the node space of the output data of the n-th output node. If the input data is provided by one output node, the node space of the output node is also stored, and if the input data of the n-th output node is not provided by the output node, only the node space of the output data of the n-th output node needs to be reserved.

The node space corresponding to the input node of the output node that the node space has not been distributed needs to be reserved in the current node space, because the output node needs to be used for performing calculation on later output nodes that the node space has not been distributed to, the output node needs to be reserved firstly to be convenient for subsequent use; if the node space is released, the data that can be used will not be found during subsequent use, and the node space of other output nodes that can't be used later will be released.

In an embodiment of the present disclosure, if there is no output node that satisfies the release condition, there is no node space that can be released.

Step S10328, distributing an a-th node space to an a-th output node in a second storage space, according to the space size of the a-th output node.

In an embodiment of the present disclosure, if the node is the last output node, it is necessary to distribute the global space to the output node, instead of distributing the node space in dynamic spaces of the first output node to an (a−1)-th output node.

In an embodiment of the present disclosure, the first node space to the a-th node space constitute the space information of the target device block

It should be noted that, after the node space is distributed to the last output node, the node space corresponding to the output node in the current node space that satisfies the release condition can also be released, and if there is no node space corresponding to the output node that satisfies the release condition, the release is not performed.

Step S10329, determining a maximum storage space occupied by the a output nodes based on the first node space to the a-th node space.

In an embodiment of the present disclosure, after the node space is distributed to each output node, a maximum value of a total storage space that is occupied by all the output nodes can be obtained, because the storage spaces occupied by some output nodes are the same, the maximum storage space should be less than the sum of the node spaces of all the output nodes.

For example, if the first output node occupies 5 bytes of space, the second output node occupies 8 bytes of space, the third output node occupies the space that is released by the first output node, with 3 bytes of space, in this way, the maximum storage space occupied by the three output nodes is 5+8=13 bytes of space.

It should be noted that, since the node space that is distributed to the a-th output node is in the second storage space, and all node spaces that are distributed to other output nodes are in the first storage space, the maximum storage space includes a first maximum storage space occupied by the first (a−1) output nodes, and a second maximum storage space occupied by the a-th output node, wherein the second maximum storage space is the a-th node space.

In an embodiment of the present disclosure, the space is distributed to the target device block, on the one hand, the node space of the output node in the device block can be obtained, which is convenient to be invoked, on the other hand, a total space size of all the target device blocks corresponding to each device type can also be obtained, to facilitate the heterogeneous platform to distribute the spaces to the deep learning network when the heterogeneous platform is deployed. According to the present disclosure, unused data can be released after the node space is distributed, so that only the data that needs to be used at present is reserved in a module that stores the node space, the data is cleaner and unpolluted during operating the deep learning network, which ensures normal operation of the deep learning network. Moreover, the node space can be reused, which is conducive to space reuse.

For example, the NNP target device block A is connected with the DSP target device block B and in front of the DSP target device block B.

And performing space distribution on the NNP target device block A, wherein only one layer of calculation is determined by a function implementation mode of the NNP target device block, so that only one group of output data in the NNP target device block A is available, performing node space distribution on the output node corresponding to the output data in the NNP target device block A, adding 1 to the index code of the target device block after distribution is completed, and then performing space distribution on a next target device block.

And performing space distribution on the DSP target device block B, wherein multi-layer calculation is determined by a function implementation mode of the DSP target device block, so that a plurality of groups of output data exist in the DSP target device block B, performing node space distribution on the output node corresponding to each layer of output data in the DSP target device block B, adding 1 to the index code of the target device block after distribution is completed, and then performing space distribution on the next target device block.

For example, a specific implementation of distributing the node space is shown in FIG. 7:
if 6 output nodes in the target device block need to be performed node space distribution, then:
firstly, distributing the node space to a first output node, and directly growing a space with a size of 1 (a buffer space), to obtain a first node space.

Secondly, distributing a node space to a second output node, wherein the second output node has two output data that needs to be distributed, and growing spaces with sizes of 2 and 3, respectively, so that a second node space is formed by the spaces with the sizes of 2 and 3. The space with the size of 1 does not need to be released because the input node of the second output node includes the first output node.

Thirdly, distributing the node space to a third output node, wherein the third output node has one output data, and growing a space with a size of 4, and the space with the size of 4 is a third node space, because the input node of the third output node includes the second output node, the spaces with the sizes of 2 and 3 do not need to be released, and the first output node is not the input node of the output node that has not been distributed the space, so the space with the size of 1 is released.

Fourthly, distributing the node space to a fourth output node, wherein the fourth output node has one output data, and growing a space with a size of 5, and the space with the size of 1 that has been released can satisfy use requirements of the space with the size of 5, so the space with the size of 5 can occupy the space with the size of 1 that has been released, in this way, the space with the size of 5 is a fourth node space, because the input node of the fourth output node includes the third output node, the space with the size of 4 does not need to be released; the space with the size of 2 can be released when it is no longer used, and the space with the size of 3 can be reserved because it needs to be used later.

Fifthly, distributing the node space for a fifth output node, wherein the fifth output node has one output data, and growing a space with a size of 6, so that the space with the size of 6 is a fifth node space. Since the input node of the fifth output node includes the fourth output node, the space with the size of 5 does not need to be released, and the space with the size of 4 can be released because it is no longer used.

Sixthly, a sixth output node is the last output node, what needs to be distributed is the global space, only the node space that has been dynamically distributed is displayed in FIG. 7, which will not be distributed or displayed in FIG. 7, and a sixth node space can be obtained by distributing the space to the sixth output node; in addition, in the step, the node space of the output node that is not used any more can be released, and the space with the size of 3 can be released because it is no longer used.

Based on the above distribution of the node spaces, as can be seen from FIG. 7, both the fourth node space and the fifth node space are occupied the spaces that have been released by previous output nodes, and therefore, the maximum storage space occupied by the first output node to the sixth output node is the sum of the first node space, the second node space, the third node space and the sixth node space.

Step S104, deploying the deep learning network to the heterogeneous platform based on the topological structure diagram, the network parameter, the function information, the target device block and the space information.

In an embodiment of the present disclosure, after the target device blocks are completed by dividing the nodes, and the node spaces are configured for the target device blocks, the target device blocks can be deployed to the heterogeneous platform, according to an order of the target device blocks that has been arranged, and the target device blocks are deployed one by one through the index codes of the target device blocks when deploying the target device blocks.

Referring to FIG. 8, in a possible implementation, an implementation process of the step S104 can include:

step S1041, obtaining deployment information of an m-th target device block based on the input data of the input node, the output data of the output node, the space information, the function information, and the network parameter that are in the m-th target device block arranged according to the preset rule.

In an embodiment of the present disclosure, different device types require different deployment information, which need to collect the input data and the output data of the target node in the target device block for deployment, the input data includes structure information of the data, space information of the data, and information of the input data that is included in the information of the node, the information of the output data that is collected is the same as that of the input data, and then the input data and data of the output node are combined into input data and output data that are structured.

The deployment information includes the structured input data, the output data, the function information, the network parameter, and device configuration information of a corresponding device on the heterogeneous platform, the device configuration information is pre-stored and set according to the device type, and the device configuration information can include information such as the number of image processing, a code length, and how to start the code.

For example, if it is the NNP target device block and the function information is an assembly code compiled by the TVM complier, the NNP target device block needs to put the structured input data, the output data, the assembly code compiled by the TVM complier, and the network parameter into an NNP compiling tool for compiling, so as to generate a binary code, and the deployment information includes the binary code, the structured output data, the structured output data and the device configuration information.

If it is the DSP target device block and the function information is function information of each layer of functions in the DSP target device block, and the deployment information includes the function information of each layer of functions in the DSP target device block, the structured input data of each layer of functions, the structured output data of each layer of functions and device configuration information.

It should be noted that, if it is an online deployment, after the deployment information is collected, overhead information needs to be added to the deployment information, and is set according to the device scheduling, which can include the number of layers of the target device block, the input data and the output data of the target device block etc.

Step S1042, determining whether the deployment information of the m-th target device block satisfies a deployment condition, wherein the deployment condition is that the m-th target device block does not need to wait for output data of a (m−1)-th target device block to serve as input data.

In an embodiment of the present disclosure, since the target device blocks are deployed in order, the current target device block can need to take output data of a previous target device block as its input data, and if the previous target device block does not obtain the output data, the current target device block can't obtain the input data, so that the target device block can't be deployed, and the target device block needs to wait for obtaining the data and then continue to be deployed.

Step S1043, if the deployment condition of the m-th target device block satisfies the deployment condition, sending the deployment information of the m-th target device block to a device with the same device type as that of the target device block of the m-th target device block in the heterogeneous platform.

In an embodiment of the present disclosure, when the deployment condition is satisfied, the input data of the m-th target device block is completely collected, and the deployment information can be directly assembled into a corresponding section or a message to be sent to a corresponding device without waiting for the output data of the (m−1)-th target device block.

Step S1044, if the deployment information of the m-th target device block does not satisfy the deployment condition, after obtaining the output data of the (m−1)-th target device block, sending the deployment information of the m-th target device block to the device with the same device type as that of the target device block of the m-th target device block in the heterogeneous platform.

In an embodiment of the present disclosure, when the deployment condition isn't satisfied, the m-th target device block needs to wait for the output data of the (m−1)-th target device block to be taken as its input data, the deployment is interrupted, after the (m−1)-th target device block is completely calculated and the output data of the (m−1)-th target device block is obtained, the deployment information can be directly assembled into the corresponding section or the message to be sent to the corresponding device.

In an embodiment of the present disclosure, dividing the nodes in the topological structure diagram into the target device blocks corresponding to the device types of the heterogeneous platform through obtaining the information of the nodes in the topological structure diagram generated by the TVM compiler, and then, performing space distribution on the target device blocks, to obtain space information of each target device block, and finally deploying the information of each target device block to a device of the heterogeneous platform, based on the obtained network parameter, the function information of each function, the topological structure diagram, the target device blocks and the space information of the target device blocks generated by the TVM compiler, so as to complete deployment of the heterogeneous platform. The present disclosure divides the nodes into the target device blocks with different device types, and completes the deployment of different devices in the heterogeneous platform through different types of target device blocks; in this way, compared with the prior art in which only a single device platform can be deployed, the present disclosure can ensure integrity of the deep learning network, and deploy the deep learning network based on the TVM compiler, to support the deep learning network that has been obtained by different deep learning frameworks.

It should be noted that the deployment method of the present disclosure is not only applicable to the online deployment, but also applicable to an offline deployment. The deployment information only needs to be stored in a corresponding bin file during performing the offline deployment, the bin file generally includes a network structure bin file and a network parameter bin file, and then the bin file is developed and analyzed on the heterogeneous platform, and the deployment is performed according to a structure of the target device block.

In a possible implementation, an implementation process of the step S102 can further include:
dividing the nodes into candidate device blocks corresponding to each device type, to obtain target nodes included in each of the candidate device blocks, based on the information of the node and the device type, each device type including at least one candidate device block;
determining the input node and the output node of each target device block, according to information of the target node in the target device block; and
arranging the candidate device blocks according to the preset rule, and merging the candidate device blocks that are continuous and belong to the same device type, to obtain the target device block.

In an embodiment of the present disclosure, when the candidate device blocks are merged, if the candidate device block is the NNP device block, the input node and the output node for internal transmission need to be removed from the candidate device block to be merged, and only the input node and the output node of the final target device block are left, and if the candidate device block is the DSP device block, it only needs to merge the input node and the output node.

For example, taking the NNP candidate device block as an example, the candidate device block A has the input nodes a and b, and the output node c that is the target node in the candidate device block A; the candidate device block B has the input nodes c and d, and the output node e that is the target node in the candidate device block B; the candidate device block A and the candidate device block B are merged into the target device block C, in this way, the input nodes of the target device block C are a, b and d, and the output node of the target device block C is e.

It should be understood that, sequence numbers of the steps in the foregoing embodiments do not imply an execution sequence, and the execution sequence of each process should be determined by its function and inherent logic, and should not constitute any limitation to the implementation process of the embodiments of the present disclosure.

Corresponding to the deployment method of the heterogeneous platform based on the TVM compiler described in the foregoing embodiment, FIG. 9 is a schematic structural diagram of a deployment device of the heterogeneous platform based on the TVM compiler according to an embodiment of the present disclosure, and for convenience of illustration, only parts related to the embodiment of the present disclosure are shown.

Referring to FIG. 9, the deployment device 300 can include: a data acquisition module 310, a node dividing module 320, a space distribution module 330, and a network deployment module 340.

The data acquisition module 310 is configured to obtain a topological structure diagram, a network parameter and function information of each function of a deep learning network generated by the TVM compiler;
the node dividing module 320 configured to divide nodes in the topological structure diagram into target device blocks corresponding to device types, based on information of the nodes in the topological structure diagram and the device types of the heterogeneous platform;
the space distribution module 330 configured to perform space distribution on the target device block, to obtain space information of the target device block; and
the network deployment module 340 configured to deploy the deep learning network to the heterogeneous platform, based on the topological structure diagram, the network parameter, the function information, the target device block and the space information of the target device block.

In a possible implementation, the node dividing module 320 can specifically include:
a module dividing unit configured to divide the nodes into the candidate device blocks corresponding to each device type, to obtain target nodes included in each of the candidate device blocks, based on the information of the node and the device type, each device type including at least one candidate device block;
a module sorting unit configured to arrange the candidate device blocks according to a preset rule, and merge the candidate device blocks that are continuous and belong to the same device type, to obtain the target device block; and
an input and output node determining unit configured to determine an input node and an output node of each target device block, according to information of the target node in the target device block.

In a possible implementation, the information of the node includes a node type of the node, a device type of the node, input data of the node, and output data of the node;
the module dividing unit can specifically be configured to:
determine whether each node in the topological structure diagram satisfies a classification condition; and
if an i-th node satisfies the classification condition of the node, divide the i-th node into a j-th candidate device block corresponding to the device type of the i-th node, according to the device type of the i-th node; wherein i and j are greater than or equal to 1, when i=1, the classification condition of a first node is that the node type is a function type, and when i>1, the classification condition of the i-th node is that the node type of the i-th node is the function type, and input data of the i-th node is output data of a node in the j-th candidate device block or output data of a previous layer of nodes in the j-th candidate device block; wherein the nodes in the topological structure diagram are distributed layer by layer from top to bottom, and the previous layer of nodes in the j-th candidate device block refers to a layer of nodes distributed outside the j-th candidate device block and closest to the j-th candidate device block on the j-th candidate device block.

In a possible implementation, the module dividing unit can be further specifically configured to:
if the i-th node does not satisfy the classification condition, divide the i-th node into a (j+1)-th candidate device block corresponding to the device type of the i-th node, according to the device type of the i-th node, wherein no node exists in the (j+1)-th candidate device block.

In a possible implementation, the input and output node determining unit can be specifically configured to:
if the input node of the target node in the target device block satisfies an input node inclusion condition, the input node of the target node is included in a current target device block and taken as the input node of the target device block; wherein the input node inclusion condition includes that, when the input node of the target node is a node of the data type, corresponding data is input data of the deep learning network, or the input node of the target node is a node of the function type and is not included in the current target device block; and
the target node in the target device block that satisfies an output node inclusion condition is the output node of the current target device block, wherein the output node inclusion condition includes, that the target node is in an output list of the deep learning network, or the output data of the target node is the input data of the target node in the target device block except the current target device block.

In a possible implementation, the space distribution module 330 can specifically include:
a space calculation unit configured to calculate a space size of each output node, based on scale information and the data type of each output node in the target device block; and
a space distribution unit configured to obtain a maximum storage space required to be occupied by all the output nodes, based on the space size of each output node, and take the maximum storage space as the space information of the target device block.

In a possible implementation, the space distribution unit can specifically be configured to:
sort a output nodes according to an input and output order, to obtain an output node queue that has been sorted;
distribute a first node space to a first output node in a first storage space, based on the space size of the first output node;
search a target node space in the node space that has been distributed, according to the space size of an n-th output node, wherein the target node space is a node space that is currently idle and larger than the space size of the n-th output node, and 2≤n≤a−1;
if the target node space exists in the node space that has been distributed, distribute an n-th node space to the n-th output node in the target node space, according to the space size of the n-th output node;
if the target node space does not exist in the node space that has been distributed, distribute the n-th node space to the n-th output node after a (n−1)-th node space, according to the space size of the n-th output node;
determine whether there is the output node satisfying a release condition in all current node spaces, after the n-th node space is distributed to the n-th output node;
if the output node satisfying the release condition exists in all the current node spaces, release the node space of the output node that satisfies the release condition, wherein the node space that has been released is idle;
distribute an a-th node space to an a-th output node in a second storage space, according to the space size of the a-th output node; and
determine a maximum storage space occupied by the a output nodes, based on the first node space to the a-th node space.

In a possible implementation, the network deployment module 340 can specifically be configured to:
obtain deployment information of an m-th target device block, based on the input data of the input node, the output data of the output node, the space information, the function information, and the network parameter that are in the m-th target device block arranged according to the preset rule;
determine whether the deployment information of the m-th target device block satisfies a deployment condition, wherein the deployment condition is that the m-th target device block does not need to wait for output data of a (m−1)-th target device block to serve as input data; and
if the deployment condition of the m-th target device block satisfies the deployment condition, send the deployment information of the m-th target device block to a device with the same device type as that of the target device block of the m-th target device block in the heterogeneous platform.

In a possible implementation, the network deployment module 340 can specifically be further configured to:
if the deployment information of the m-th target device block does not satisfy the deployment condition, after obtaining output data of the (m−1)-th target device block, send the deployment information of the m-th target device block to the device with the same device type as that of the target device block of the m-th target device block in the heterogeneous platform.

It should be noted that information interaction and execution processes between the above devices/units are based on the same conception as the embodiments of the present disclosure, therefore, specific functions and technical effects brought by the above devices/units can be detailed in the embodiments of the present method, which is not be repeated here.

An ordinary skilled person in the art can be clearly understood that: for convenient and simple description, the above functional units and modules are only divided to illustrate with examples. In a practical application, different functional units and modules can be assigned to implement the above functions according to needs, that is, internal structures of the apparatus can be divided into different functional units or modules to complete all or part of the functions described above. Each functional unit or each module in embodiments of the present disclosure can be integrated in a processing unit, or each unit can be physically existed separately, or two or more units can be integrated in a unit. The above-mentioned integrated units can be realized in the form of hardware or software functional units. In addition, specific names of each functional unit and each module are only to conveniently distinguish with each other, but are not limited to the protection scope of the present disclosure. A specific working process of the units and modules in the above system can be referred to the corresponding process in the embodiment of the above method, which is not repeated here.

A computer readable storage medium according to an embodiment of the present disclosure is configured to store computer programs performed by a processor to implement steps of the deployment method of the heterogeneous platform based on the TVM compiler mentioned above.

A computer program product according to an embodiment of the present disclosure is configured to be performed by a terminal device to implement steps of the deployment method of the heterogeneous platform based on the TVM compiler mentioned above.

1. A deployment method of a heterogeneous platform based on a TVM compiler comprising:
obtaining a topological structure diagram, a network parameter and function information of each function of a deep learning network generated by the TVM compiler;
dividing nodes in the topological structure diagram into target device blocks corresponding to device types, based on information of the nodes in the topological structure diagram and the device types of the heterogeneous platform;
performing space distribution on the target device block, to obtain space information of the target device block; and
deploying the deep learning network to the heterogeneous platform, based on the topological structure diagram, the network parameter, the function information, the target device block and the space information of the target device block.

2. The deployment method as claimed in claim 1, wherein the step of obtaining the topological structure diagram, the network parameter and the function information of each function of the deep learning network generated by the TVM compiler, comprises:
dividing the nodes into candidate device blocks corresponding to each device type, to obtain target nodes comprised in each of the candidate device blocks, based on the information of the nodes and the device types, each device type comprising at least one candidate device block;
arranging the candidate device blocks according to a preset rule, and merging the candidate device blocks that are continuous and belong to the same device type, to obtain the target device block; and
determining an input node and an output node of each target device block, according to information of the target node in the target device block.

3. The deployment method as claimed in claim 2, wherein the information of the node comprises a node type of the node, a device type of the node, input data of the node, and output data of the node;
the step of dividing the nodes into the candidate device blocks corresponding to each device type, to obtain the target nodes comprised in each of the candidate device blocks, based on the information of the nodes, comprising:
determining whether each node in the topological structure diagram satisfies a classification condition; and
if an i-th node satisfies the classification condition of the nodes, dividing the i-th node into a j-th candidate device block corresponding to the device type of the i-th node according to the device type of the i-th node; wherein i and j are greater than or equal to 1, when i=1, the classification condition of a first node is that the node type is a function type, and when i>1, the classification condition of the i-th node is that the node type of the i-th node is the function type, and input data of the i-th node is output data of a node in the j-th candidate device block or output data of a previous layer of nodes in the j-th candidate device block; wherein the nodes in the topological structure diagram are distributed layer by layer from top to bottom, and the previous layer of nodes in the j-th candidate device block refers to a layer of nodes distributed outside the j-th candidate device block and closest to the j-th candidate device block on the j-th candidate device block.

4. The deployment method as claimed in claim 3, wherein after determining whether each node in the topological structure diagram satisfies the classification condition, the method further comprising:
if the i-th node does not satisfy the classification condition, dividing the i-th node into a (j+1)-th candidate device block corresponding to the device type of the i-th node, according to the device type of the i-th node, wherein no node exists in the (j+1)-th candidate device block.

5. The deployment method as claimed in claim 2, wherein the step of determining the input node and the output node of each target device block, according to the information of the target nodes in the target device blocks, comprises:
if the input node of the target node in the target device block satisfies an input node inclusion condition, the input node of the target node is comprised in a current target device block and taken as the input node of the target device block; wherein the input node inclusion condition comprises that, when the input node of the target node is the node of the data type, corresponding data is input data of the deep learning network, or the input node of the target node is the node of the function type and is not comprised in the current target device block; and
the target node in the target device block that satisfies an output node inclusion condition is the output node of the current target device block, wherein the output node inclusion condition comprises, that the target node is in an output list of the deep learning network, or the output data of the target node is the input data of the target node in the target device block except the current target device block.

6. The deployment method as claimed in claim 5, wherein the step of performing space distribution on the target device block, to obtain the space information of the target device block, comprises:
calculating a space size of each output node, based on scale information and the data type of each output node in the target device block; and
obtaining a maximum storage space required to be occupied by all the output nodes, based on the space size of each output node, and taking the maximum storage space as the space information of the target device block.

7. The deployment method as claimed in claim 6, wherein the step of obtaining the maximum storage space required to be occupied by all the output nodes, based on the space size of each output node, comprises:
sorting a output nodes according to an input and output order, to obtain an output node queue that has been sorted;
distributing a first node space to a first output node in a first storage space, based on the space size of the first output node;
searching a target node space in the node space that has been distributed, according to the space size of an n-th output node, wherein the target node space is a node space that is currently idle and larger than the space size of the n-th output node, and 2≤n≤a−1;
if the target node space exists in the node space that has been distributed, distributing an n-th node space to the n-th output node in the target node space, according to the space size of the n-th output node;
if the target node space does not exist in the node space that has been distributed, distributing the n-th node space to the n-th output node after a (n−1)-th node space, according to the space size of the n-th output node;
determining whether there is the output node satisfying a release condition in all current node spaces, after the n-th node space is distributed to the n-th output node;
if the output node satisfying the release condition exists in all the current node spaces, releasing the node space of the output node that satisfies the release condition, wherein the node space that has been released is idle;
distributing an a-th node space to an a-th output node in a second storage space, according to the space size of the a-th output node; and
determining the maximum storage space occupied by the a output nodes, based on the first node space to the a-th node space.

8. The deployment method as claimed in claim 2, wherein the step of deploying the deep learning network to the heterogeneous platform, based on the topological structure diagram, the network parameter, the function information, the target device block and the space information of the target device block, comprises:
obtaining deployment information of an m-th target device block, based on the input data of the input node, the output data of the output node, the space information, the function information, and the network parameter that are in the m-th target device block arranged according to the preset rule;
determining whether the deployment information of the m-th target device block satisfies a deployment condition, wherein the deployment condition is that the m-th target device block does not need to wait for output data of a (m−1)-th target device block to serve as input data; and
if the deployment condition of the m-th target device block satisfies the deployment condition, sending the deployment information of the m-th target device block to a device with the same device type as that of the target device block of the m-th target device block in the heterogeneous platform.

9. The deployment method as claimed in claim 8, wherein after determining whether the deployment information of the m-th target device block satisfies the deployment condition, the method further comprises:
if the deployment information of the m-th target device block does not satisfy the deployment condition, after obtaining output data of the (m−1)-th target device block, sending the deployment information of the m-th target device block to the device with the same device type as that of the target device block of the m-th target device block in the heterogeneous platform.

10. A deployment device of a heterogeneous platform based on a TVM compiler and applied to an electronic apparatus, the electronic apparatus comprising a processor and a memory and one or more computerized program modules stored in the memory, the one or more computerized program modules comprising instructions performed by the processor of the electronic apparatus, the modules comprising:
a data acquisition module performed by the processor and configured to obtain a topological structure diagram, a network parameter and function information of each function of a deep learning network generated by the TVM compiler;
a node dividing module performed by the processor and configured to divide nodes in the topological structure diagram into target device blocks corresponding to device types, based on information of the nodes in the topological structure diagram and the device types of the heterogeneous platform;
a space distribution module performed by the processor and configured to perform space distribution on the target device block, to obtain space information of the target device block; and
a network deployment module performed by the processor and configured to deploy the deep learning network to the heterogeneous platform, based on the topological structure diagram, the network parameter, the function information, the target device block and the space information of the target device block.

11. A terminal device comprising a memory, a processor and computer programs stored in the memory and performed by the processor, when the computer programs are performed by the processor, the terminal device can be configured to implement steps of a deployment method of a heterogeneous platform based on a TVM compiler, the deployment method comprising:
obtaining a topological structure diagram, a network parameter and function information of each function of a deep learning network generated by the TVM compiler;
dividing nodes in the topological structure diagram into target device blocks corresponding to device types, based on information of the nodes in the topological structure diagram and the device types of the heterogeneous platform;
performing space distribution on the target device block, to obtain space information of the target device block; and
deploying the deep learning network to the heterogeneous platform, based on the topological structure diagram, the network parameter, the function information, the target device block and the space information of the target device block.

12. (canceled)
